(19) United States
(12) Patent Application Publication
(10) Pub. No.: US 2015/0331573 A1
(43) Pub. Date: Nov. 19, 2015

(54) HANDHELD MOBILE TERMINAL DEVICE AND METHOD FOR CONTROLLING WINDOWS OF SAME

(71) Applicants: HISENSE MOBILE COMMUNICATIONS TECHNOLOGY CO., LTD., Qingdao (CN); HISENSE USA CORP., Suwanee, GA (US)

(72) Inventors: Ping-Yang Zhu, Qingdao (CN); Xin Zhang, Qingdao (CN); Guo-Chen Sun, Qingdao (CN); Jiu-Fa Huang, Qingdao (CN)

(21) Appl. No.: 14/455,362

(22) Filed: Aug. 8, 2014

(30) Foreign Application Priority Data
May 15, 2014 (CN) 201410205619.6

(51) Int. Cl. G06F 3/0488; G06F 3/0482; G06F 3/0484; G06F 3/0481

(52) U.S. Cl. CPC G06F 3/0488; G06F 3/04817; G06F 3/0482; G06F 3/04842

(57) ABSTRACT

In one aspect, a handheld mobile terminal device is provided. The handheld mobile terminal device includes a touch screen and a plurality of applications respectively corresponding to a plurality of windows. The handheld mobile terminal device also has a non-transitory storage medium storing a computer readable program code which, when executed by one or more processors, implements a window control method. The method includes: detecting a first touch operation in a preset area of the touch screen; if the first touch operation is detected in the preset area, displaying a window control icon in a first area of the touch screen; detecting a second touch operation corresponding to the window control icon in the first area; and if the second touch operation corresponding to the window control icon is detected in the first area, transforming the windows in response to the second touch operation.

### CROSS-REFERENCE TO RELATED APPLICATION

This application claims the priority to Chinese Patent Application No. 201410205619.6, filed on May 15, 2014, in the State Intellectual Property Office of P.R. China, which is hereby incorporated herein in its entirety by reference.

### FIELD OF THE DISCLOSURE

The present disclosure relates to a window control method used in a handheld mobile terminal device and a handheld mobile terminal device.

### BACKGROUND

When using a mobile terminal device, a user often keeps multiple applications executed simultaneously. For example, a user may execute instant messaging software, an e-book reader software, a video player, and the like simultaneously. When each of the instant messaging software, the e-book reader software or the video player is executed, the corresponding window of each application is usually displayed in a full-screen manner. If a user needs to chat with others using the instant messaging software, and to read an e-book using the e-book reader software simultaneously, the user needs to switch frequently between full-screen windows of the two pieces of software.

### SUMMARY

One aspect of the present disclosure provides a window control method for a handheld mobile terminal device having a touch screen, where the handheld mobile terminal device comprises a plurality of applications respectively corresponding to a plurality of windows. In one exemplary embodiment, the method includes:

detecting a first touch operation in a preset area of the touch screen;

if the first touch operation is detected in the preset area, displaying a window control icon in a first area of the touch screen;

detecting a second touch operation corresponding to the window control icon in the first area; and

if the second touch operation corresponding to the window control icon is detected in the first area, transforming the windows in response to the second touch operation.

Another aspect of the present disclosure provides a window control method for a handheld mobile terminal device having a touch screen, where the handheld mobile terminal device comprises a plurality of applications respectively corresponding to a plurality of windows. In one exemplary embodiment, the method includes:

detecting a first touch operation corresponding to an image button;

displaying a window control icon in a first area of the touch screen;

detecting a second touch operation corresponding to the window control icon in the first area; and

transforming the windows in response to the second touch operation.

In a further aspect of the present disclosure, a handheld mobile terminal device is provided, which includes a touch screen, one or more processors, and a non-transitory storage medium storing a computer readable program code. The computer readable program code stored in the non-transitory storage medium is configured to be executed by the one or more processors to implement a window control method. The method includes:

detecting a first touch operation in a preset area of the touch screen;

if the first touch operation is detected in the preset area, displaying a window control icon in a first area of the touch screen;

detecting a second touch operation corresponding to the window control icon in the first area; and

if the second touch operation corresponding to the window control icon is detected in the first area, transforming the windows in response to the second touch operation.

These and other aspects of the disclosure will become apparent from the following description of several exemplary embodiments taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more exemplary embodiments of the disclosure and together with the written description, serve to explain the principles of the disclosure. Wherever possible, the same reference numbers are used throughout the drawings to refer to the same or like elements of an exemplary embodiment.

FIG. 1 is a schematic flow chart showing a window control method for a handheld mobile terminal device application according to one exemplary embodiment of the present disclosure.

FIG. 2 is a schematic view showing a layout of a frame layout manager according to related art.

FIG. 3 is a schematic view showing a layout of a frame layout manager according to one exemplary embodiment of the present disclosure.

FIG. 4 is a schematic view of a window control bar located at the bottom of a display interface according to one exemplary embodiment of the present disclosure.

FIG. 5 is a schematic view of a window control bar located at the left side of a display interface according to one exemplary embodiment of the present disclosure.

FIG. 6 is a schematic view of a window control bar located at the right side of a display interface according to one exemplary embodiment of the present disclosure.

FIG. 7 is a schematic structural view of an apparatus for controlling windows of applications of a handheld mobile terminal device according to one exemplary embodiment of the present disclosure.

FIG. 8 is a schematic view showing a handheld mobile terminal device according to one exemplary embodiment of the present disclosure.

FIG. 9 is a schematic view showing a different state of the handheld mobile terminal device as shown in FIG. 8.

FIG. 10 is a schematic view showing a further different state of the handheld mobile terminal device as shown in FIG. 8.

FIG. 11 is a schematic view showing a handheld mobile terminal device according to one exemplary embodiment of the present disclosure.

FIG. 12 is a schematic view showing a different state of the handheld mobile terminal device as shown in FIG. 11.

FIG. 13 is a schematic view showing tiled windows of a handheld mobile terminal device according to one exemplary embodiment of the present disclosure.

FIG. 14 is a schematic view showing tiled windows of a handheld mobile terminal device according to one exemplary embodiment of the present disclosure.

FIG. 15 is a schematic view showing tiled windows of a handheld mobile terminal device according to one exemplary embodiment of the present disclosure.

FIG. 16 is a schematic view showing tiled windows of a handheld mobile terminal device according to one exemplary embodiment of the present disclosure.

FIG. 17 is a schematic view showing tiled windows of a handheld mobile terminal device according to one exemplary embodiment of the present disclosure.

FIG. 18 is a schematic view showing cascaded windows of a handheld mobile terminal device according to one exemplary embodiment of the present disclosure.

FIG. 19 is a schematic view showing cascaded windows of a handheld mobile terminal device according to one exemplary embodiment of the present disclosure.

FIG. 20 is a schematic view showing cascaded windows of a handheld mobile terminal device according to one exemplary embodiment of the present disclosure.

FIG. 21 is a schematic view showing cascaded windows of a handheld mobile terminal device according to one exemplary embodiment of the present disclosure.

FIG. 22 is a schematic view showing cascaded windows of a handheld mobile terminal device according to one example embodiment of the present disclosure.

FIG. 23 is a schematic view showing cascaded windows of a handheld mobile terminal device according to one exemplary embodiment of the present disclosure.

FIG. 24 is a schematic view showing cascaded windows of a handheld mobile terminal device according to one exemplary embodiment of the present disclosure.

FIG. 25 is a schematic view showing cascaded windows of a handheld mobile terminal device according to one exemplary embodiment of the present disclosure.

FIG. 26 is a schematic structural view showing a handheld mobile terminal device according to one exemplary embodiment of the present disclosure.

FIG. 27 is a schematic view showing minimized windows of a handheld mobile terminal device according to one exemplary embodiment of the present disclosure.

### DETAILED DESCRIPTION OF THE DISCLOSURE

The disclosure will now be described hereinafter with reference to the accompanying drawings, in which several exemplary embodiments of the disclosure are shown. This disclosure may, however, be embodied in many different forms and should not be construed as limited to the exemplary embodiments set forth herein.

The terms used in this specification generally have their ordinary meanings in the art, within the context of the disclosure, and in the context where each term is used. Certain terms that are configured to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various exemplary embodiments given in this specification.

It will be understood that, although the terms first, second, third etc. may be used herein to describe various elements, components, regions, layers and/or sections, these elements, components, regions, layers and/or sections should not be limited by these terms. These terms are only configured to distinguish one element, component, region, layer or section from another element, component, region, layer or section. Thus, a first element, component, region, layer or section discussed below could be termed a second element, component, region, layer or section without departing from the teachings of the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising,” “including,” “having,” “containing,” “involving,” and the like are to be understood to be open-ended, i.e., to mean including but not limited to.

As used herein, the term “unit”, or “module” may refer to, be part of, or include software and/or hardware components, such as an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term unit or module may also include memory (shared, dedicated, or group) that stores code executed by the processor.

As used herein, the term “transforming the windows” may refer to one or more operations or actions of modifying, adjusting or arranging the appearances of the windows on a display screen. The operations may include, without being limited to, adjusting the size of the windows, minimizing the windows, maximizing the windows to a full screen mode, and/or arranging the windows in a certain arrangement, such as the cascade arrangement, tile arrangement, or any other arrangement of the windows.

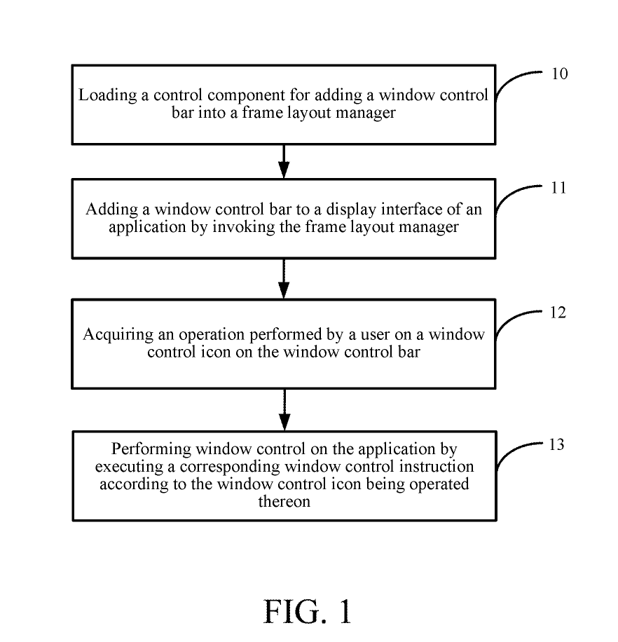

The description will be made as to the exemplary embodiments of the disclosure in conjunction with the accompanying drawings in FIGS. 1-27. It should be understood that exemplary embodiments described herein are merely used for explaining the disclosure, but are not intended to limit the disclosure. In accordance with the purposes of this disclosure, as embodied and broadly described herein, this disclosure, in certain aspects, relates to a window control method used in a handheld mobile terminal device and a handheld mobile terminal device.

One exemplary embodiment of the present disclosure provides a window control method for an application of a handheld mobile terminal device, which is applicable to various terminal devices. The handheld mobile terminal device may, for example, be a portable wireless communication device small enough to be held by a hand and with display, circuitry, and battery in a single unit, such as a tablet computer, a cellular telephone, or a smart phone. A desktop computer or a laptop computer is not a handheld mobile terminal. The handheld mobile terminal device may also include or may execute a variety of operating systems, including an operating system, such as a mobile operating system, such as iOS, ANDROID, or WINDOWS MOBILE.

In certain exemplary embodiments of the present disclosure, when an application is initialized, a control for adding a window control bar is loaded into a frame layout manager. When the application is started, a window control bar is added to a display interface of the application by invoking the control, in the frame layout manager, for adding a window control bar, where the window control bar includes at least one window control icon, and each window control icon corresponds to one window control instruction. When an operation performed by a user on the window control icon on the window control bar is acquired or detected, window control is performed on the application by executing a corresponding window control instruction according to the operated window control icon.

The exemplary embodiments of the present disclosure will be hereinafter described in details below with reference to the accompanying drawings.

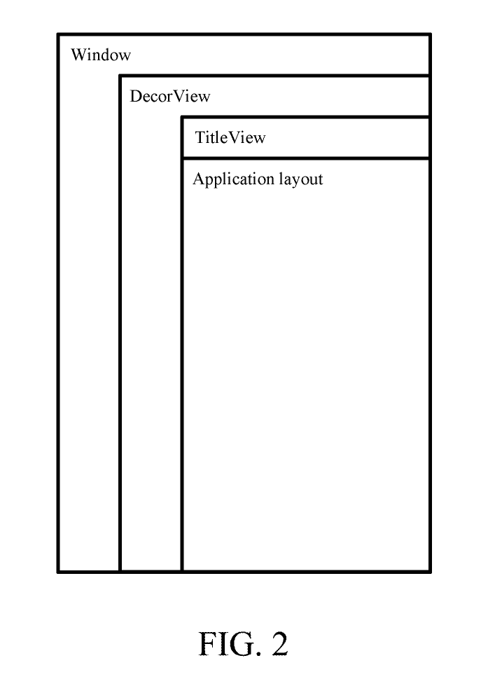

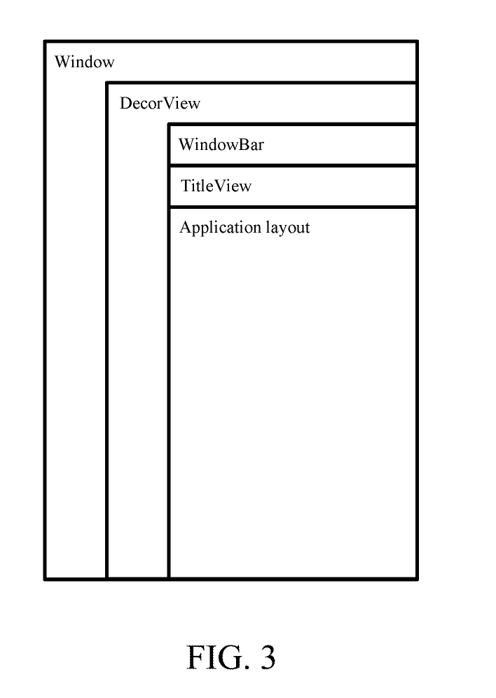

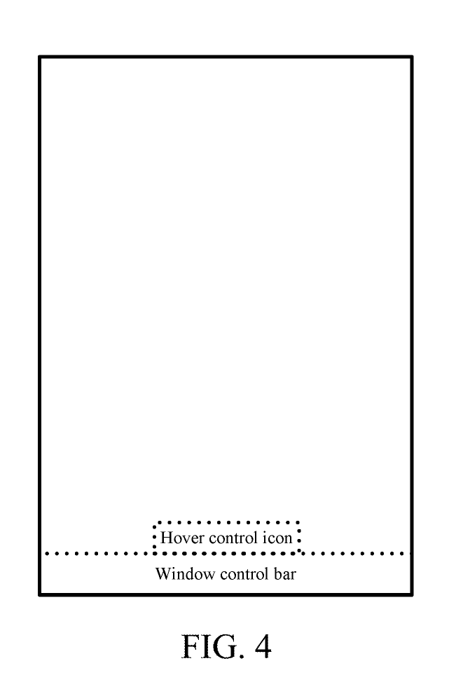

FIG. 1 is a schematic flow chart showing a window control method for a handheld mobile terminal device application according to one exemplary embodiment of the present disclosure. Based on the method provided in FIG. 1, FIGS. 2 and 3 are schematic views showing a process of loading a window control bar according to certain exemplary embodiments of the present disclosure, and FIGS. 4 to 6 are schematic views of the window control bar being located at different locations of a display interface according to certain exemplary embodiment of the present disclosure. As shown in FIG. 1, the method includes the following steps:

Step S10: When an application is initialized, loading a control component for adding a window control bar into a frame layout manager.

In actual implementation, conventionally, when an application (Activity) is initialized, a window, that is, a PhoneWindow, is allocated to each Activity. FIG. 2 is a schematic view showing a layout of a frame layout manager according to related art. As shown in FIG. 2, the PhoneWindow has a frame layout manager DecorView for loading a display interface of an application. The frame layout manager DecorView is a frame layout manager (FrameLayout) of an inheritance structure of a ViewGroup. The FrameLayout is a simple layout manager, where all control components in the layout are stacked hierarchically at a specified location of the screen, and control components added subsequently cover preceding control components. In certain exemplary embodiments of the present disclosure, a control component for adding a window control bar is added to the frame layout manager. The control component may be an operating system control component. When an application is started, the control component for adding a window control bar may be used to add a window control bar to a display interface of the application. Thus, the frame layout manager includes not only an ActionBar and a TitleView, but also the control component (WindowBar) for adding a window control bar.

FIG. 3 schematically shows a layout structure of loading the control component (WindowBar) for adding a window control bar into the display interface of the application according to the exemplary embodiment of the present disclosure. As shown in FIG. 3, in certain exemplary embodiments of the disclosure, when the DecorView is initialized, the control component (WindowBar) for adding a window control bar may be loaded into the display interface of the application by invoking a setContentView interface of the Activity. In addition, the ActionBar and the TitleView may be loaded into the display interface of the application. ActionBar is a control component which is a window feature for identifying an application and the user location, and provides user actions and navigation modes, and TitleView is a control component for performing layout of a title bar.

Step S11: When the application is started, adding a window control bar to a display interface of the application by invoking the frame layout manager.

In actual implementation, in certain exemplary embodiments of the present disclosure, a Window may also be obtained by invoking a getWindow interface of the Activity, and DecorView is obtained by invoking a getDecorView interface. Then, the DecorView is added to the display interface of the application, and the WindowBar is loaded into the display interface of the application. Thus, when the application is started, the function of adding a window control bar to the display interface of the application is implemented by invoking the frame layout manager. Further, in certain exemplary embodiments of the present disclosure, ActionBar and TitleView may also be loaded into the display interface of the application.

It should be noted that, in certain exemplary embodiments of the present disclosure, DecorView is automatically initialized when invoking setContentView or getDecorView. In this case, WindowBar, ActionBar, and TitleView may be loaded sequentially or randomly into the display interface of the application. Preferably, in certain exemplary embodiments of the present disclosure, the layer of the WindowBar may be ensured to be above the display interface of the application, ActionBar, and TitleView.

In one exemplary embodiment, at Step S11, the window control bar may include at least one window control icon, and each window control icon corresponds to one window control instruction.

In actual implementation, the WindowBar in certain exemplary embodiments of the present disclosure may include one or more window control icons, and each window control icon corresponds to one window control instruction. The window control icon is used for receiving a window control instruction which is sent by a user by tapping a touch screen or by clicking with a mouse. It should be noted that, in certain exemplary embodiments of the present disclosure, the window control instruction may include at least a close instruction, a size adjustment instruction, a maximization instruction, a minimization instruction, a window drag instruction, and the like.

In one exemplary embodiment, at Step S11, the window control bar further includes a hover control icon, and a window control instruction corresponding to the hover control icon is to display a hidden window control bar. After the window control bar is added to the display interface of the application, the method may further include: if an operation performed by a user corresponding to the window control icon of the window control bar is not acquired or detected within a preset period of time, hiding the window control icon on the window control bar, and maintaining the hover control icon.

Step S12: Acquiring an operation performed by a user on a window control icon on the window control bar.

In certain exemplary embodiments, at Step S12, after adding the window control bar to the display interface of the application, when a drag operation performed by the user corresponding to the window control bar is acquired or detected, a target location of the window control bar is determined according to the drag operation, where the target location is an edge location of the display interface of the application. Then, the window control bar is moved from the current location to the target location.

In actual implementation, a window control instruction sent by a user by tapping a touch screen or clicking with a mouse is acquired or detected. When the window control instruction is identified as a window drag instruction, current location information of the WindowBar in the display interface of the application is recorded, and according to the drag operation, target location information of the WindowBar expected by the user is determined and recorded. Then the WindowBar is moved from the current location to the target location.

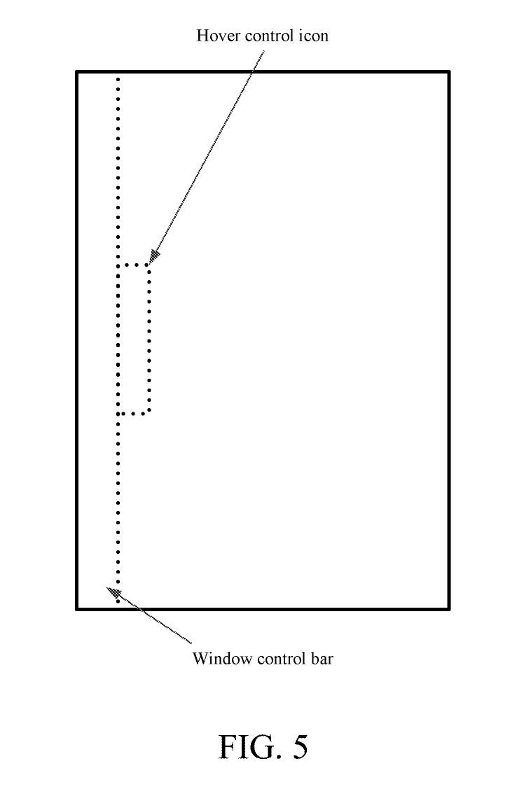

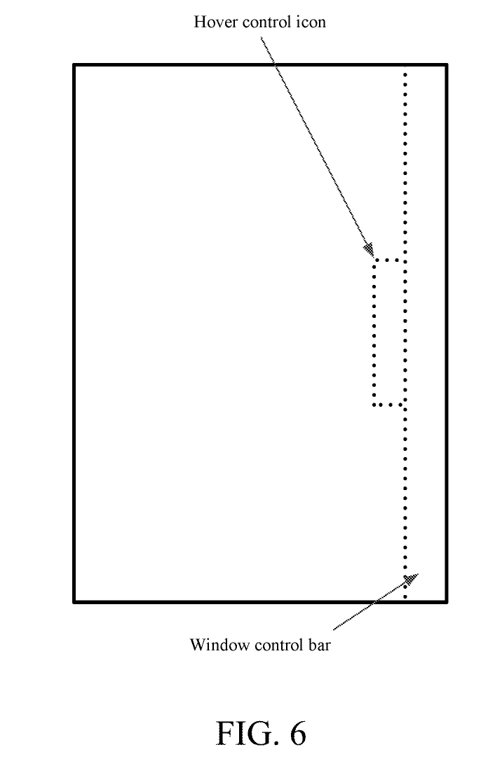

Optionally, as shown in FIG. 4, in certain exemplary embodiments of the present disclosure, an initial location of the WindowBar may be set at the bottom of the display interface of the application. As shown in FIG. 5, the WindowBar may be moved to the left side of the display interface of the application. As shown in FIG. 6, the WindowBar may also be moved to the right side of the display interface of the application. Further, the WindowBar may also be moved to other areas of the display interface of the application.

In one exemplary embodiment, at Step S12, after adding the window control bar to the display interface of the application, if an operation performed by the user for switching the application is acquired or detected, a color of a window control bar in a display interface of an application being switched to a non-focused application is changed to a first color, and a color of a window control bar in a display interface of an application being switched to a focused application is changed to a second color, where the first color is different from the second color.

In actual implementation, a window control instruction sent by a user by tapping a touch screen or clicking a mouse is acquired or detected. When the window control instruction is identified as an application switching instruction, the color of the window control bar in the display interface of the application being switched into a non-focused application is changed to the first color, and the color of the window control bar in the display interface of the application being switched into a focused application is changed to the second color. It should be noted that, for all applications being switched into non-focused applications, the window control bars in their display interfaces may all be in the first color, since there is only one focused application, and applications other than the focused application are all non-focused applications. Accordingly, in certain exemplary embodiments of the present disclosure, the color of the WindowBar may be changed, so that a user can distinguish whether the application is or is not a focused application based on the change of the color of the WindowBar, thus improving user experience.

Step S13: After the operation performed by the user on the window control icon on the window control bar is acquired, performing window control to the application by executing a corresponding window control instruction according to the window control icon being operated thereon.

In one exemplary embodiment, at Step S13, after the operation performed by the user on the window control icon on the window control bar is acquired or detected, if an operation being acquired or detected is performed by the user on a close instruction icon on the window control bar, a corresponding application window is closed.

In an actual implementation, if an operation performed by a user on a close instruction icon on the window control bar is acquired or detected, a finish( )method of a system Activity is invoked to close the corresponding application window.

In one exemplary embodiment, at Step S13, after the operation performed by the user on the window control icon on the window control bar is acquired or detected, if an operation being acquired or detected is performed by the user on a window size adjustment instruction icon on the window control bar, the size of the window is adjusted according to a range of the currently acquired or detected operation.

In actual implementation, if an operation performed by a user on a window size adjustment instruction icon on the window control bar is acquired or detected, the function of adjusting the size of the window is implemented by invoking a setAttributes method of a system Window and by setting new height and width.

In one exemplary embodiment, at Step S13, after the operation performed by the user on the window control icon on the window control bar is acquired or detected, if an operation being acquired or detected is performed by the user on a maximization instruction icon on the window control bar, a corresponding application window is maximized.

In actual implementation, if an operation performed by a user on a maximization instruction icon on the window control bar is acquired or detected, the window size is maximized by invoking a setAttributes method of a system Window.

In one exemplary embodiment, at Step S13, after the operation performed by the user on the window control icon on the window control bar is acquired or detected, if an operation being acquired or detected is performed by the user on a minimization instruction icon on the window control bar, a corresponding application window is minimized.

In actual implementation, if an operation performed by a user on a minimization instruction icon on the window control bar is acquired or detected, a Visibility of the application is set to false by using setAppVisibility in WindowManager, thereby minimizing the corresponding application window.

As discussed above, in certain exemplary embodiments of the present disclosure, the WindowBar can be loaded into the display interface of the application by using an Android system control component. In addition, in certain exemplary embodiments of the present disclosure, a plurality of window control icons with different functions may be added to the WindowBar for acquiring or detecting different operation instructions from a user, so that a more thorough comprehensive window control function is provided without affecting normal display and use of the application. In this way, existing applications developed based on the Android system are further humanized, thus improving the flexibility of user operation and user experience.

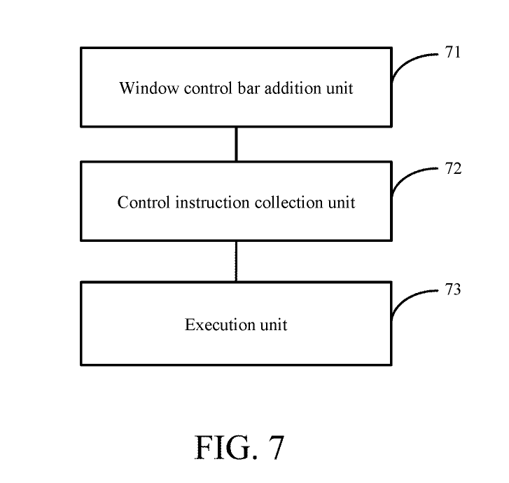

Based on the same technical conception, one exemplary embodiment of the present disclosure provides an apparatus for performing window control for an application of a handheld mobile terminal device, where the method as described above is applicable to the apparatus. As shown in FIG. 7, the apparatus includes a window control bar addition unit 71, a control instruction collection unit 72 and an execution unit 73.

The window control bar addition unit 71 is configured for: when an application is initialized, loading, into a frame layout manager, a control component for adding a window control bar; when the application is started, adding a window control bar to a display interface of the application by invoking the control component for adding a window control bar in the frame layout manager, where the window control bar includes at least one window control icon, and each window control icon corresponds to one window control instruction;

The control instruction collection unit 72 is configured for acquiring or detecting an operation performed by a user on a window control icon on the window control bar; and

The execution unit 73 is configured for: when the operation performed by the user on the window control icon is acquired or detected, performing window control to the application by executing a corresponding window control instruction according to the window control icon being operated thereon.

In one exemplary embodiment, the window control bar includes a hover control icon, and a window control instruction corresponding to the hover control icon is to display a hidden window control bar; and the execution unit 73 is further configured for: after the window control bar is added to the display interface of the application, when the control instruction collection unit 72 does not acquire or detect an operation performed by the user on the window control icon within a preset period of time, hiding the window control bar and maintaining the hover control icon.

In one exemplary embodiment, the control instruction collection unit 72 is further configured for: after the window control bar is added to the display interface of the application, acquiring or detecting a drag operation performed by the user on the window control bar; the execution unit 73 is further configured for: after the control instruction collection unit 72 acquires or detects the drag operation performed by the user on the window control bar, determining a target location of the window control bar according to the drag operation, where the target location is an edge location of the display interface of the application, and moving the window control bar from the current location to the target location.

In one exemplary embodiment, the control instruction collection unit 72 is further configured for: after the window control bar is added to the display interface of the application, acquiring or detecting a operation performed by the user for switching the application; and the execution unit 73 is further configured for: when the control instruction collection unit 72 acquires or detects the operation performed by the user for switching the application, changing a color of a window control bar in a display interface of an application being switched into a non-focused application to a first color, and changing a color of a window control bar in a display interface of an application being switched into a focused application to a second color, where the first color is different from the second color.

In one exemplary embodiment, the execution unit 73 is further specifically configured for: when the control instruction collection unit 72 acquires or detects an operation performed by the user on a close instruction icon on the window control bar, closing a corresponding application window; or, when the control instruction collection unit 72 acquires or detects an operation performed by the user on a window size adjustment instruction icon on the window control bar, adjusting the window size according to a range of the currently acquired or detected operation; or, when the control instruction collection unit 72 acquires or detects an operation performed by the user on a maximization instruction icon on the window control bar, maximizing a corresponding application window; or, when the control instruction collection unit 72 acquires or detects an operation performed by the user on a minimization instruction icon on the window control bar, minimizing a corresponding application window.

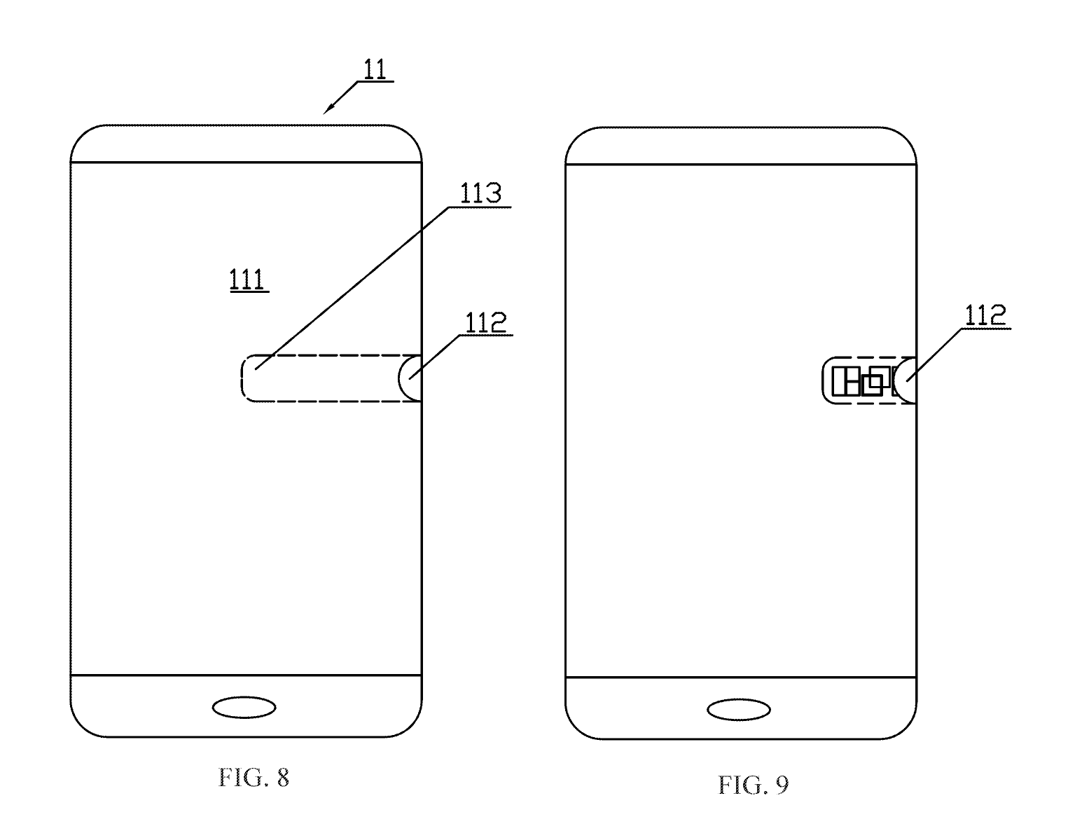

FIG. 8 is a schematic view showing a handheld mobile terminal device according to one exemplary embodiment of the present disclosure. As shown in FIG. 8, the handheld mobile terminal device may, for example, be a portable wireless communication device small enough to be held by a hand and with display, circuitry, and battery in a single unit, such as a tablet computer, a cellular telephone, or a smart phone. A desktop computer or a laptop computer is not a handheld mobile terminal device. The handheld mobile terminal device may also include or may execute a variety of operating systems, including an operating system, such as a mobile operating system, such as iOS, ANDROID, or WINDOWS MOBILE. A handheld mobile terminal device 11 shown in the drawing is in an ON state and displays a home screen. In this state, a preset area 112 is arranged at a display edge on the right side of a touch screen 111 of the handheld mobile terminal device 11, and the preset area 112 is a semicircular area.

It should be noted that the preset area 112 is not limited to being arranged at the display edge on the right side of the touch screen 111, and may be arranged at other display edges on the top side, the bottom side or the left side, or may be arranged at one of the four display corners. Alternatively, when the handheld mobile terminal device presents a multi-window state, the preset area 112 may be arranged at an edge or in a corner of one of the windows. Further, the shape of the preset area 112 is not limited to a semicircular shape, and may be a square, a triangle, a polygon, or any other shapes.

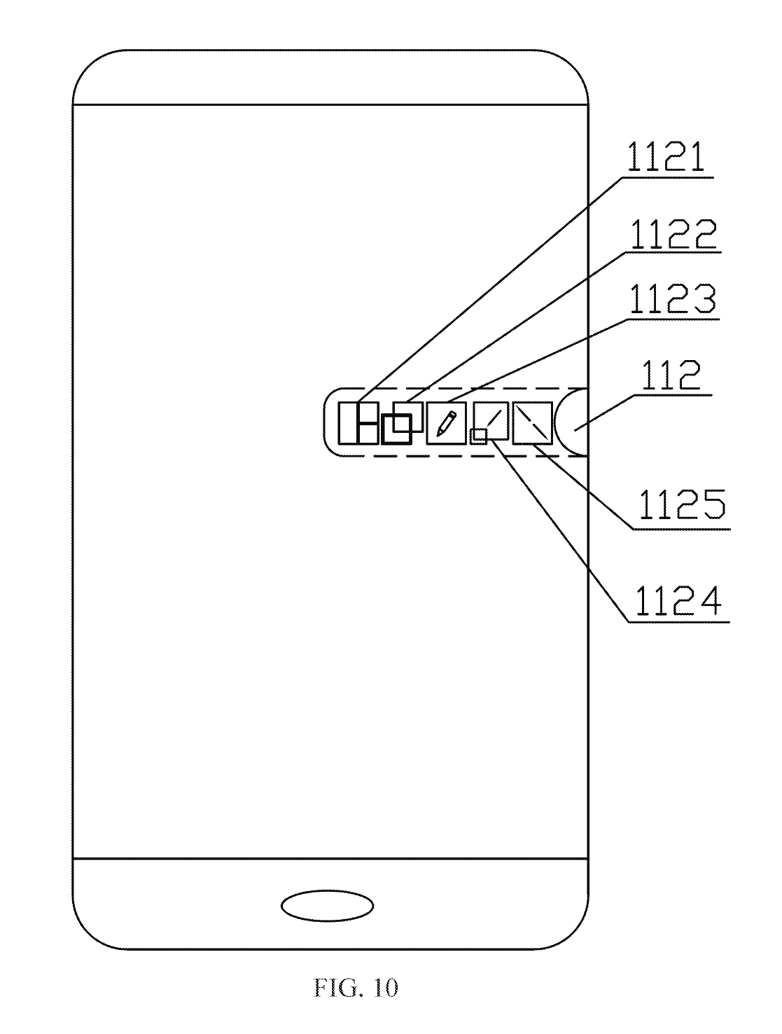

In addition, the preset area 112 may be concealed. For example, although the preset area 112 as shown in FIG. 8 is semicircular, there is no semicircular boundary, and a user does not actually see the boundary of the preset area 112. However, the handheld mobile terminal device 11 will instruct the user to find the location of the preset area 112, where the instruction may be provided by showing a guiding screen in booting or by a specification, and may also be provided by a built-in course or in a help document of the handheld mobile terminal device 11. Alternatively, the preset area 112 may also be revealed, which means that a user may directly see the location of the preset area 112. For example, the user may see the boundary of the preset area 112 as shown in FIG. 8, FIG. 9, and FIG. 10. However, the present disclosure is not limited to the revealing manifestation manner. For example, the preset area 112 may also be shown using a color, an image, an icon, and the like.

Numeral 113 represents a first area, which is bar-shaped. The right end of the first area is connected to the preset area 112. In certain exemplary embodiments, the right end of the first area may also be not in connection to the preset area 112. The left end is located in the display area of the touch screen 111. Similar to the preset area 112, the first area 113 may also be revealed or concealed. The related descriptions for the preset area 112, as discussed above, may apply for the explanation of the first area 113 being “revealed” or “unrevealed.”

When a user touches the preset area 112, the handheld mobile terminal device 11 detects a first touch operation performed by the user in the preset area 112, and then displays a window control icon in the first area 113. The window control icon may include one or more of a window maximization icon 1125, a window cascade icon 1122, a window tile icon 1121, a window scale icon 1123, and a window minimization icon 1124 (referring to FIG. 10), which are all included in the drawing. In addition, the window control icon may also enter the first area 113 dynamically. For example, the window control icon may move from a right edge of the first area 113 into the first area 113, or may also move from a top edge, a bottom edge or a left edge of the first area 113 into the first area 113. The moving of the window control icon may be in a continuous movement manner or a discontinuous movement manner.

FIG. 10 shows a display state after the window control icons have moved into the first area 113, and FIG. 9 shows a state between the states shown in FIG. 8 and FIG. 10. In other words, FIG. 9 shows an intermediate state when the window control icons are moving into the first area 113. It should be noted that FIG. 9 shows only one of the intermediate states, and there may be multiple other intermediate states, which are not shown herein.

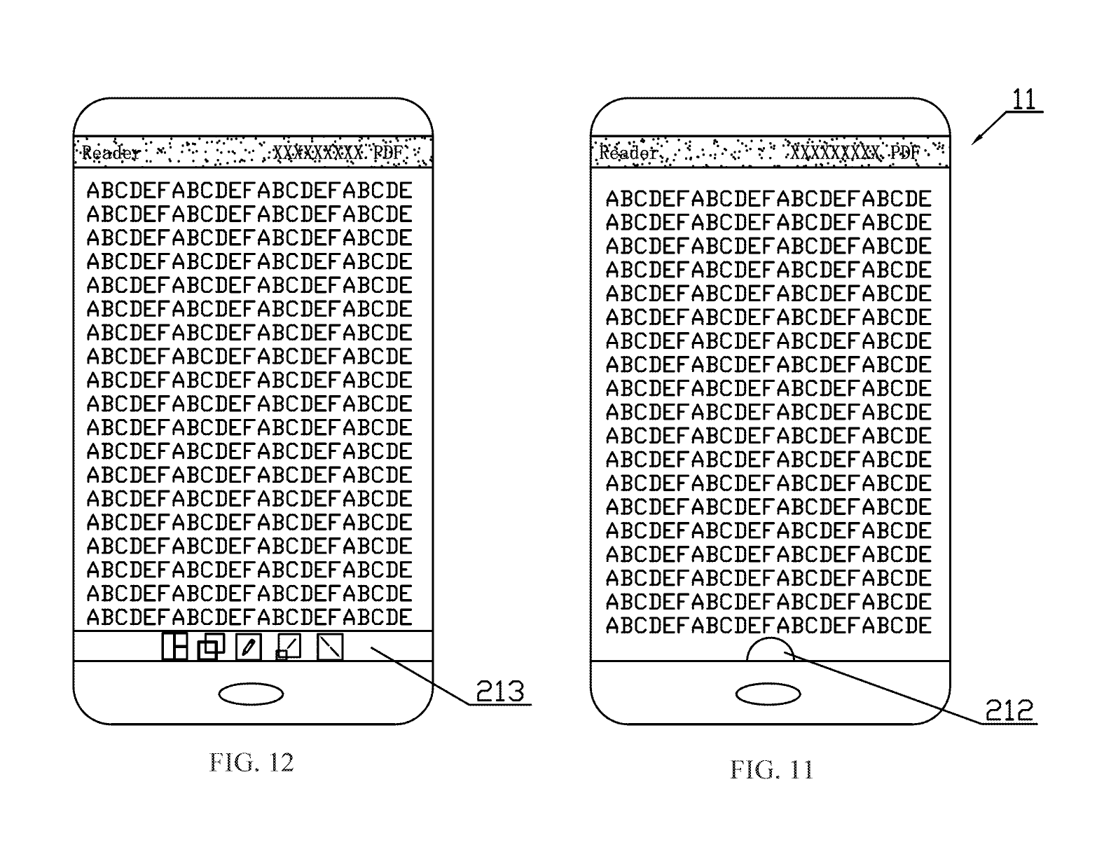

FIG. 11 shows a state after the handheld mobile terminal device 11 is powered on and starts an application according to one exemplary embodiment of the present disclosure. For example, the application may be a reader application as shown in the drawing. After the application is started, the window of the application may be in a full-screen display state as shown in the drawing. A preset area 212 is arranged at a bottom edge of the full-screen display window. When a user touches on the preset area 212, the handheld mobile terminal device 11 detects a first touch operation performed by the user and displays the corresponding window control icons (referring to FIG. 12) in a first area 213. The first area 213 is located at the bottom of the full-screen window, and is also bar-shaped but is not limited thereto. The two ends of the first area 213 extend to the side edges of the full-screen window. Similarly, the preset area 212 and the first area 213 may be concealed or revealed.

The preset area 212 may be semicircular, and may also be in any other shapes. The first area 213 may cover some display content of the full-screen window, or may also be in a semi-transparent state. The display manner of the window control icons in the first area 213 may be that the window control icons move continuously or discontinuously from an edge of the first area 213 into the first area 213.

In certain exemplary embodiments, the first area 213 may also be arranged at an edge on the left side, the right side or the top side of the full-screen window. Correspondingly, the location of the preset area 212 may be arranged corresponding to the location of the first area 213, or may be arranged independently from the first area 213. For example, the preset area 212 may be arranged at a bottom edge of the full-screen window, and the first area 213 may be arranged at the right side, the left side or the top side of the full-screen window. Similar cases may apply in the exemplary embodiment as shown in FIG. 8.

When a user touches any one of the window control icons in one of the states as shown in FIGS. 10 and 12, the handheld mobile terminal device detects a second touch operation performed by the user, and transforms the windows in response to the function of the window control icon corresponding to the second touch operation. It should be noted that all of the windows being transformed in this embodiments are the windows that are transformable.

For example, after a user performs the second touch operation by touching an icon representing the window tile function:

If only one application is currently on, the application is displayed in a full screen manner.

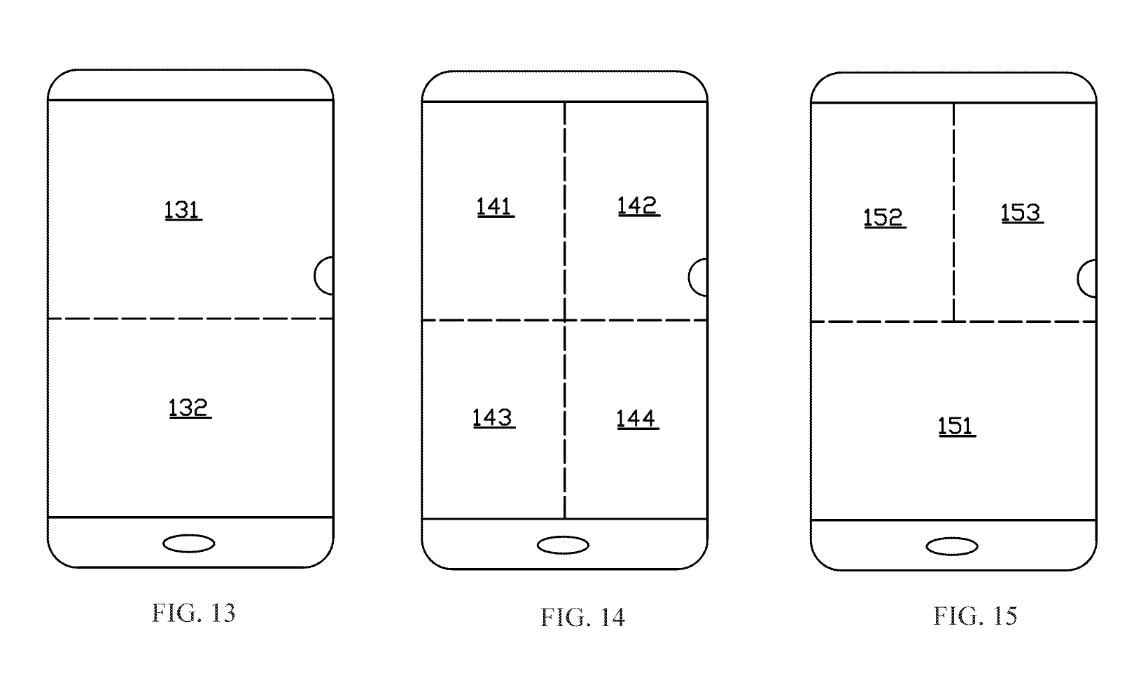

If two applications are concurrently on, and the windows of the two applications are both transformable, the display area of the touch screen is divided into two display sub-areas to separately display the two windows of the two applications correspondingly. As shown in FIG. 13, one application window may occupy an upper display sub-area 131, and the other application window may occupy a lower display sub-area 132. In certain exemplary embodiments, the two display sub-areas may be arranged by dividing the display area of the touch screen into a left part and a right part, where one application window occupies the left part, and the other occupies the right part. In certain exemplary embodiments, the two display sub-areas may be arranged by dividing the display area of the touch screen equally or unequally.

If three applications are concurrently on, and the windows of the three applications are all transformable, the display area of the touch screen is divided into three display sub-areas, and the three display sub-areas respectively display the three windows of the three applications correspondingly. As shown in FIG. 15, one application window may occupy a major part 151 (which may be ½ of the display area of the touch screen) of the display area of the touch screen, and the other two application windows together occupy the rest part of the display area of the touch screen, where one occupies a display sub-area represented by numeral 152, and the other occupies a display sub-area represented by numeral 153. In addition, the sizes of the sub-display areas 152 and 153 may be the same or different.

If four applications are concurrently on, and the windows of the four applications are all transformable, the display area of the touch screen is divided into four sub-display areas to respectively display the four windows of the four applications correspondingly. The division may be performed as shown in FIG. 14, and the sizes of the display sub-areas 141, 142, 143, and 144 may be the same or different.

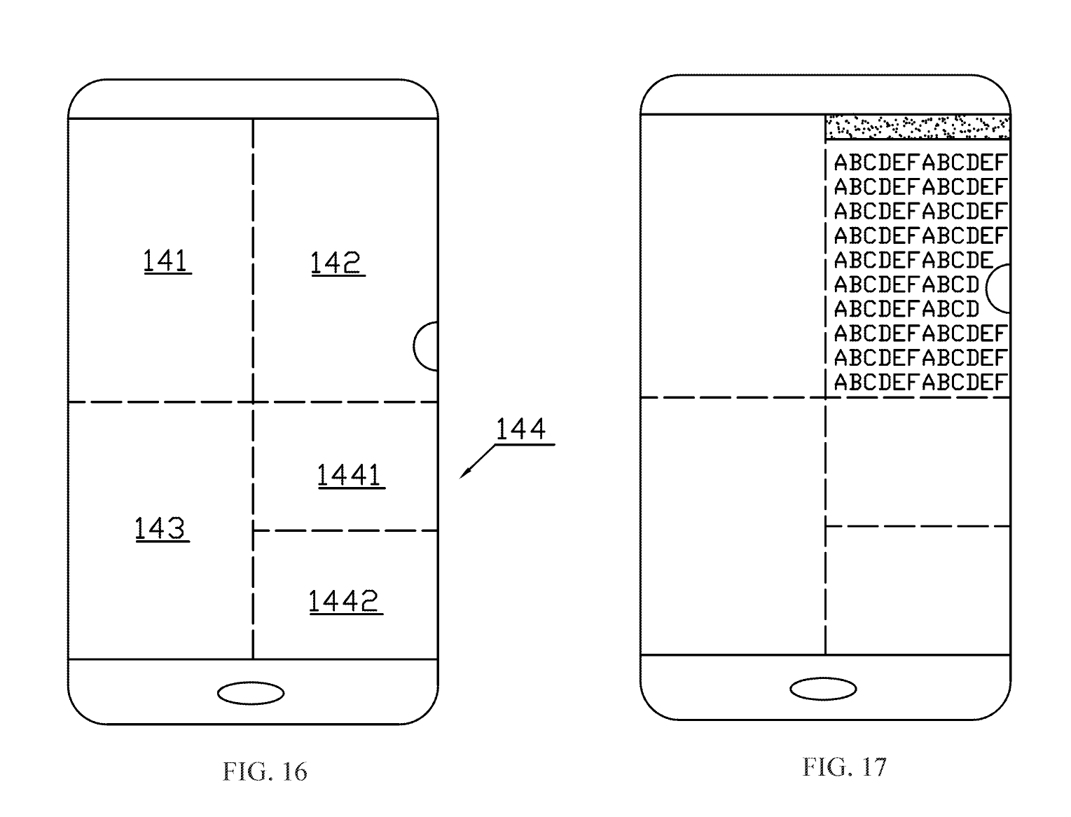

If five applications are concurrently on, and the windows of the five applications are all transformable, the display area of the touch screen is divided into five display areas to respectively display the five windows of the five applications correspondingly. The division may be performed as shown in FIG. 16. For the ease of describing the division, please refer to FIG. 14 as the basis. Based on the four display sub-areas 141, 142, 143, and 144 as shown in FIG. 14, the display sub-area 144 is further divided into two secondary areas 1441 and 1442. Similarly, the sizes of the secondary areas 1441 and 1442 may be the same or different. Therefore, a total of five display areas are formed, including three display sub-areas 141, 142, and 143 and two secondary areas 1441 and 1442.

As it is impossible to enumerate all cases, the division manner is elaborated in the following description. However, the description should not constitute any limitation to the foregoing examples.

It is assumed that after a handheld mobile terminal device detects a second touch operation, the number of all applications concurrently on is N, where N is a positive integer, and the windows of the N applications are all transformable. When N is an even number, the N windows corresponding to the N applications would divide the display area of the touch screen into N parts to obtain N display sub-areas for displaying the N windows correspondingly. In certain exemplary embodiments, the N windows may equally divide the display area of the touch screen.

When N is an odd number greater than 1, the display area of the touch screen is divided into N−1 parts to obtain N−1 display sub-areas, where the N−1 display sub-areas may equally divide the display area of the touch screen, and then one of the N−1 display sub-areas is further divided into two secondary areas. Thus, the N−2 undivided sub-display areas and the two secondary areas may be used to display the N windows correspondingly.

In addition, the dotted lines as shown in FIGS. 13-17 are used to show an effect of the division, and are not shown in actual display.

It should be noted that, a focus window prior to the division of the display area of the touch screen may still be (or may not be) the focus window after the division, so as to conform to the expectation of the user and prevent incorrect operation by mistake. In certain exemplary embodiments, the focus window after the division is disposed in an area that a user can easily access and control with the thumb. For example, as shown in FIG. 13, the window as shown in the display sub-area 132 is the focus window. As shown in FIG. 14, the window as shown in the display sub-area 143 may be the focus window, or the window as shown in the display sub-area 144 may be the focus window. As shown in FIG. 15, the window as shown in the display sub-area 151 may be the focus window. Further, as shown in FIG. 16, the window as shown in the display sub-area 143 may be the focus window.

In addition, in certain exemplary embodiments, as a possible case, the focus window after the division should not be smaller than other windows.

When a user touches any one of the window control icons in any of the states as shown in FIGS. 10 and 12, the handheld mobile terminal device detects the second touch operation performed by the user, and adjusts the windows in response to the function of the window control icon corresponding to the second touch operation.

For example, when the user touches a window cascade icon, the handheld mobile terminal device may adjusts the windows of the currently on applications to the preset sizes, and performs the cascade arrangement, so that at least some of the windows are partially invisible when presented to the user.

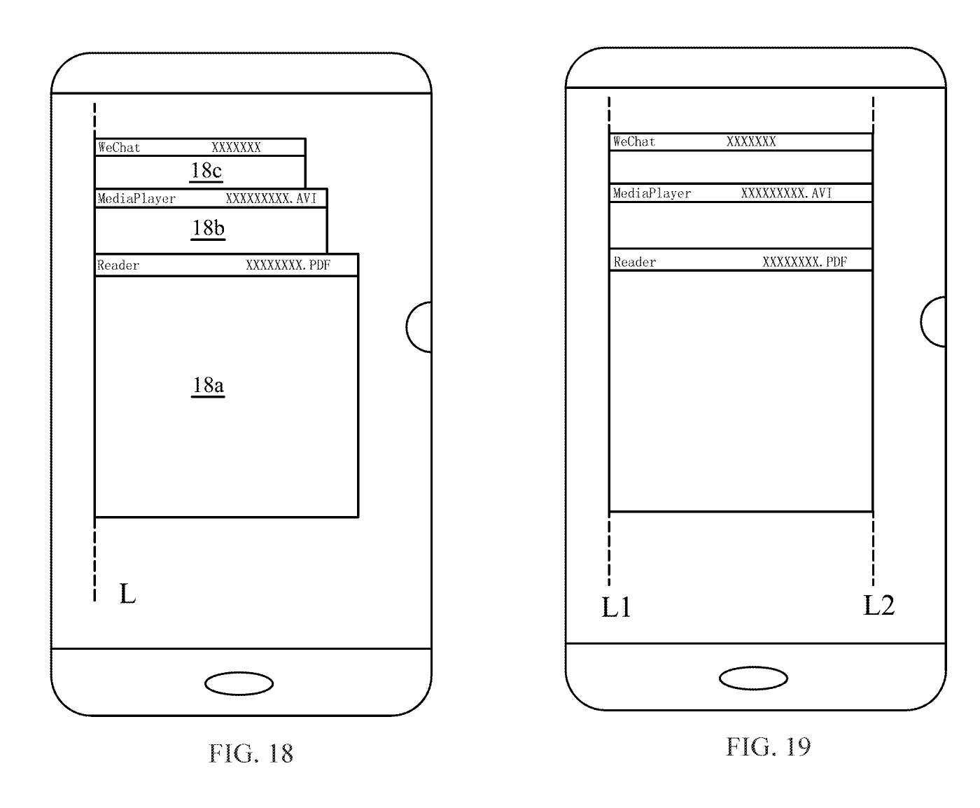

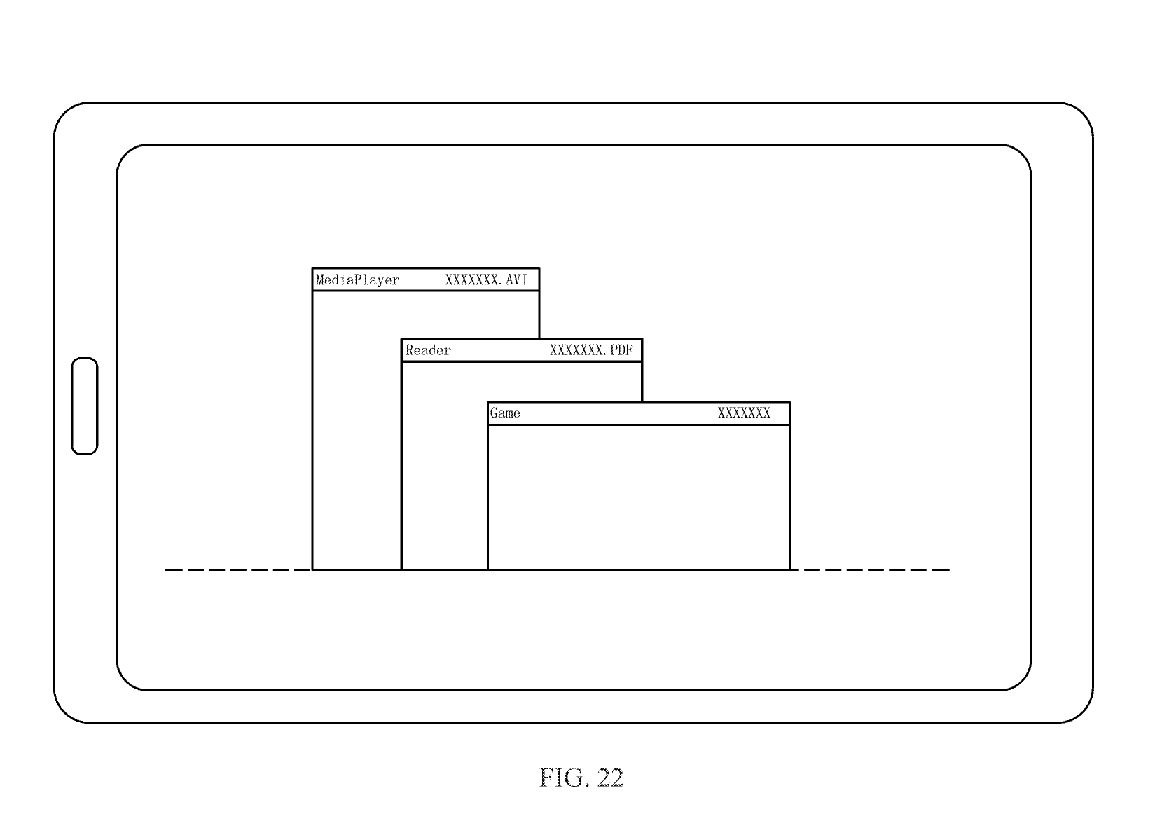

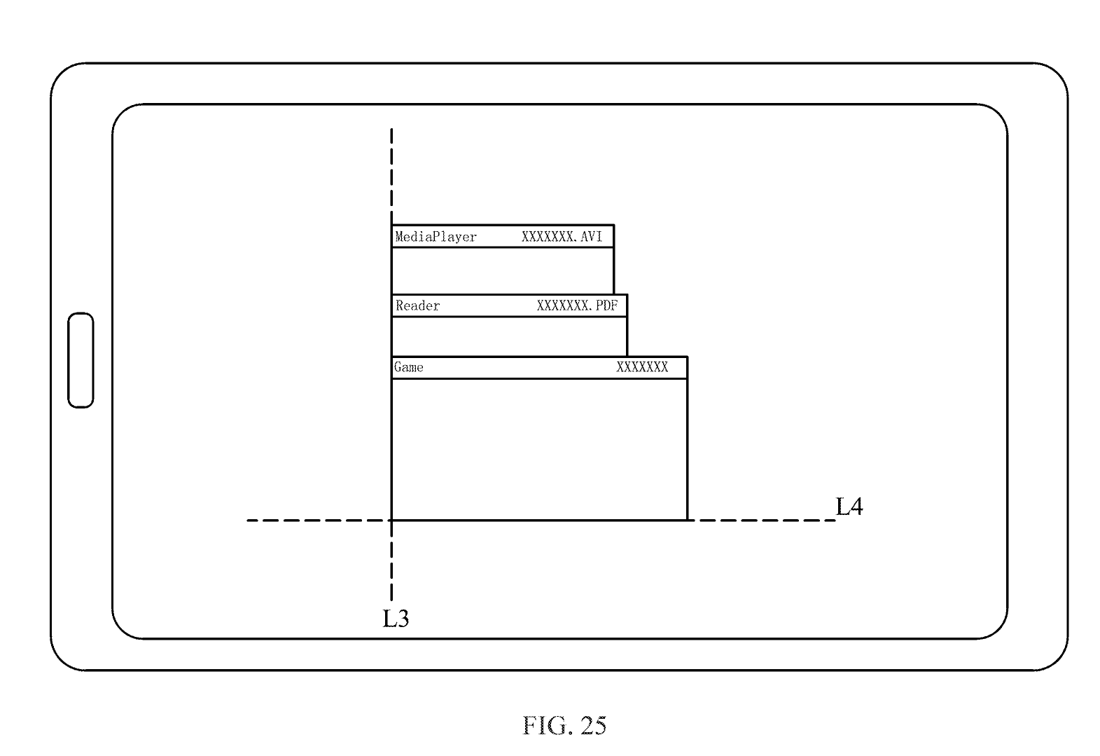

In certain exemplary embodiments, one possible case of the cascade arrangement refers to: adjusting the windows of the applications to the preset sizes, and arranging at least one edge of each of the adjusted windows on a same straight line. For example, as shown in FIG. 18, there are three applications, which respectively correspond to three windows. When a user touches a window cascade icon, all of the three windows are adjusted and reduced to the preset sizes, and the edges on the left side of the three windows are arranged to align on a same straight line L. It should be noted that the present disclosure is not limited to the case where the edges on the left side of the windows are arranged on a same straight line. In certain exemplary embodiments, it is also possible that the edges on the right side or the edges on the bottom side of the windows are arranged on a same straight line. FIG. 22 shows the case where the bottom edges are arranged on a same straight line according to one exemplary embodiment of the present disclosure. In certain exemplary embodiments, two edges of each of the three windows may be respectively arranged on same straight lines, as shown in FIG. 19. As shown in FIG. 19, the edges on the left and right sides of the three windows may be arranged to respectively align on two straight lines L1 and L2. In certain exemplary embodiments, the edges on one of the left side and the right side of the three windows and the edges on the bottom side of the three windows may be respectively arranged on same straight lines. For example, as shown in FIG. 25, the edges on the left side of the three windows are on a same straight line L3, and the edges on the bottom side of the three windows are on a same straight line L4.

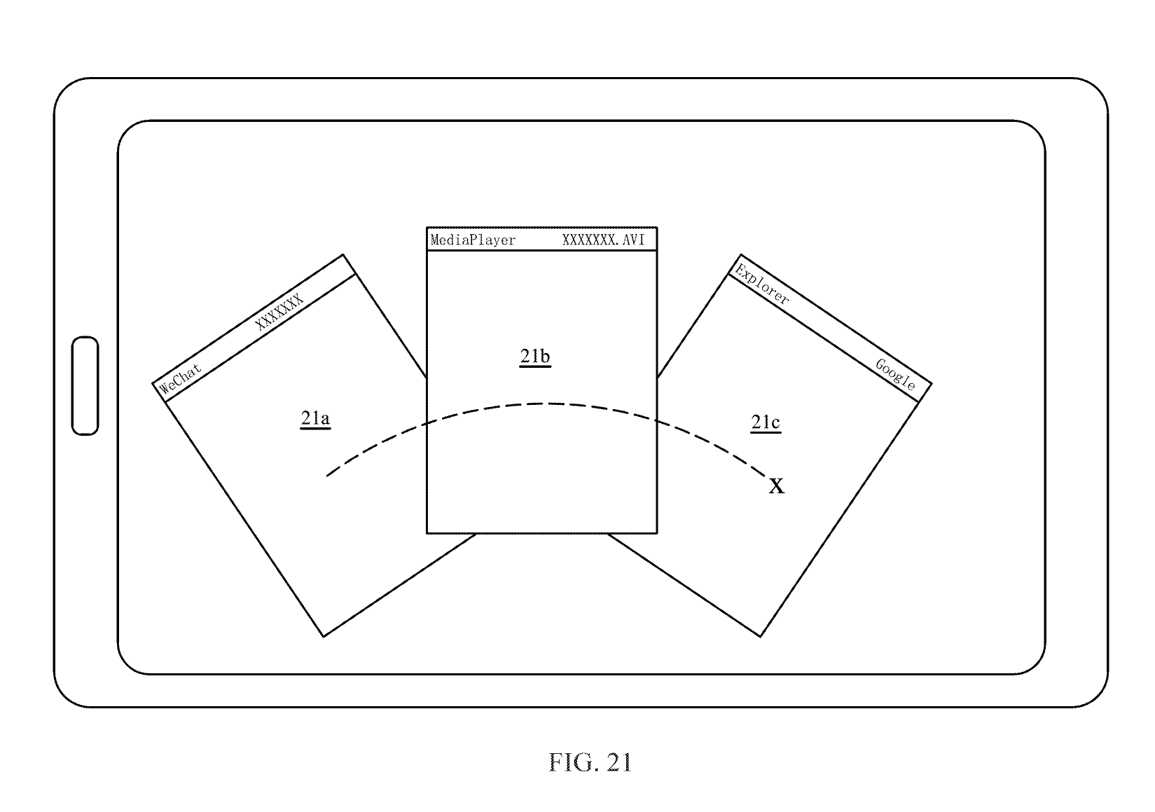

In certain exemplary embodiments, another possible case of the cascade arrangement refers to: adjusting the windows of the applications to the preset sizes, and arranging all of the windows in an arc/annular cascaded arrangement. For example, as shown in FIG. 21, the three windows 21a, 21b, and 21c in the drawing are arranged in an arc shape along an arc x, and the window 21b partially covers the windows 21a and 21c. In this case, only an arc cascade arrangement is shown. However, it can be easily understood that when the angle of an arc is 360°, the arc turns to be an annulus, and an annular cascade arrangement may be formed if there are a large number of windows. The annular arrangement may be inferred based on the description as described above, and therefore is not shown in drawings.

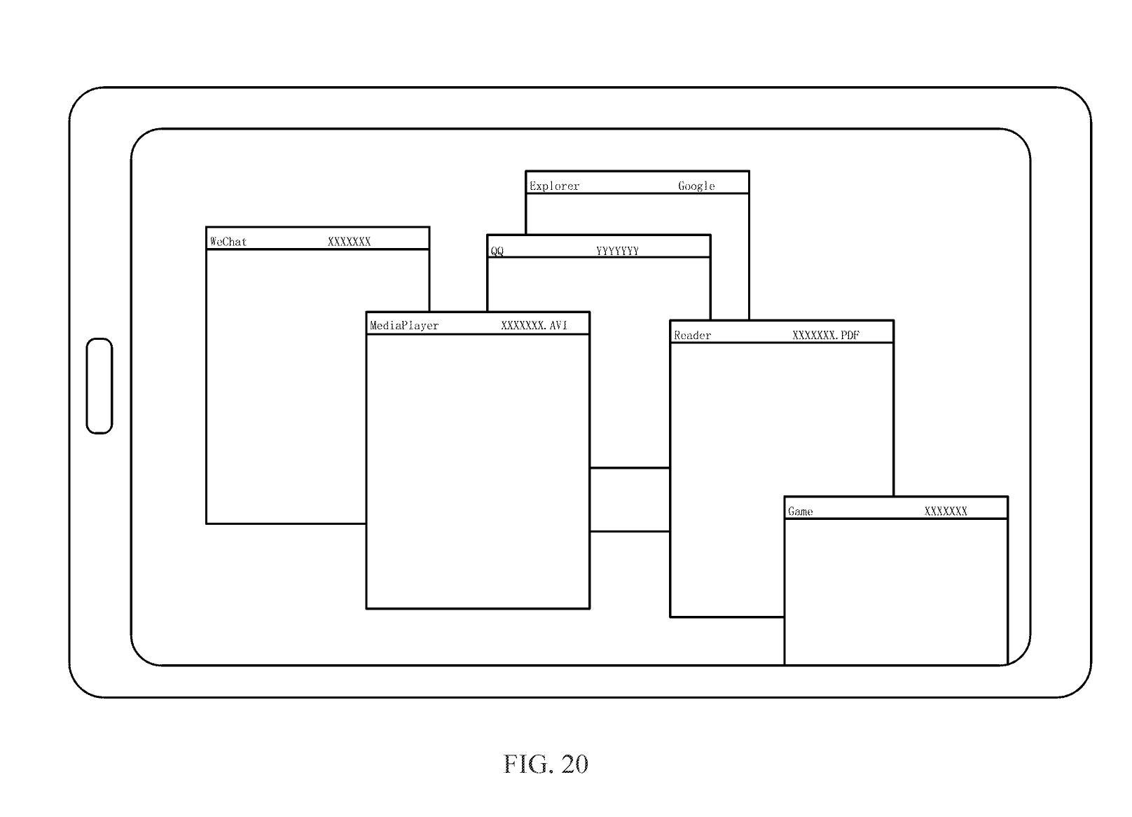

In certain exemplary embodiments, a further possible case of the cascade arrangement refers to: adjusting the windows of the applications to the preset sizes, and arranging all of the windows in a distributed cascaded arrangement. In certain exemplary embodiments, the “distributed cascaded arrangement” may be explained in a way that the centers or edges of all of the adjusted windows are arranged irregularly. For example, the cascaded manner of the six windows as shown in FIG. 20 may be regarded as a distributed cascade arrangement.

It should be noted that the cascade arrangements as described above are only exemplary descriptions, which should not constitute any limitation to manifestation manners of the cascade arrangement. In addition, in certain exemplary embodiments, in a process of a cascade arrangement of windows, the focus window prior to the cascade arrangement may be displayed as a full window after the cascade arrangement. For example, as shown in FIG. 18, there are three windows 18a, 18b, and 18c, and prior to the cascade arrangement, the focus window is 18a. Thus, after the cascade arrangement, as shown in the drawing, the window 18a is completely shown without any part of the window being covered. In another example as shown in FIG. 21, there are three windows, and the focus window prior to a cascade arrangement is the window 21b. Thus, after the cascade arrangement, as shown in the drawing, the window 21b is completely shown without any part of the window being covered.

As discussed above, the windows of the applications are adjusted to the preset sizes during the cascade arrangement operation. In certain exemplary embodiments, the adjustment to the preset sizes may be performed by adjusting the windows of all applications to a same size, or adjusting a window at the bottom layer in the cascade arrangement to a full-screen size, or adjusting the focus window to be larger than other windows, or the like.

In one exemplary embodiment of the present disclosure, the window tile icon and the window cascade icon may be implemented as one icon, which is in essence a switch. In one exemplary embodiment, if the icon is selected by the second touch operation in an original state, the tile arrangement as described above will be performed to the windows, and if the icon is again selected, the cascade arrangement as described above will be performed to the windows. Alternatively, in one exemplary embodiment, if the icon is selected by the second touch operation in an original state, the cascade arrangement as described above will be performed to the windows, and if the icon is again selected, the tile arrangement as described above will be performed to the windows.

In one exemplary embodiment of the present disclosure, a window focus switch icon is provided in the first area 113 as shown in FIG. 10. When the user performs the second touch operation by selecting the window focus switch icon, the handheld mobile terminal device switches the current focus window in a certain order. In certain exemplary embodiments, for each time the user performs the second touch operation by selecting the window focus switch icon, the current focus window is corresponding switched. The focus window is set to be displayed on the top such that the user may perform operation directly to the focus window. Assuming that, for example, the window corresponding to the area 151 as shown in FIG. 5 was the focus window prior to switching the focus. When the user selects the window focus switch icon, the focus window may be switched from the window corresponding to the area 151 to the window corresponding to the area 152. When the user selects the window focus switch icon again, the focus window may be switched from the window corresponding to the area 152 to the window corresponding to the area 153. Subsequently, when the user selects the window focus switch icon once again, the focus window may be switched back to the window corresponding to the area 151. In certain embodiments, the window serving as the focus window will explicitly indicate itself to the user for having the focus. For example, the focus window may be indicated by displaying with bolded/highlighted edges.

In a further exemplary embodiment, assuming that, for example, the window 18a as shown in FIG. 18 was the focus window prior to switching the focus. When the user selects the window focus switch icon, the focus window may be switched from the window 18a to the window 18b, and the window 18b is now displayed on the top. When the user selects the window focus switch icon again, the focus window may be switched from the window 18b to the window 18c, and the window 18c is now displayed on the top. Subsequently, when the user selects the window focus switch icon once again, the focus window may be switched back to the window 18a, and the window 18a is now displayed on the top.

In one exemplary embodiment, when the focus of the windows is switched, the display areas of the new focus window and the old focus window on the touch screen may switch places. For example, as shown in FIG. 18, when the old focus window is the windows 18a and the new focus window is the window 18b, by performing a switching operation, the display areas of the windows 18a and 18b will switch places, and the window 18b is now displayed on the top.

In one exemplary embodiment, the focus window switching operation may be performed by pressing one or more physical buttons of the handheld mobile terminal device. For example, the user may press the volume button of the handheld mobile terminal device to switch the focus window.

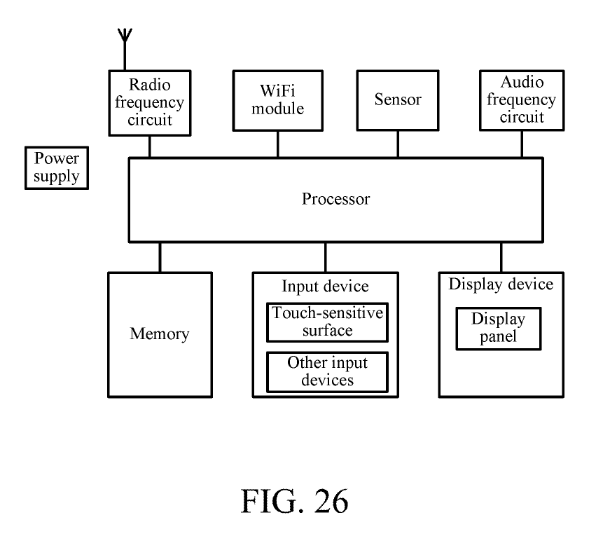

In one exemplary embodiment, the focus window switching operation may be performed by an acceleration sensor, which detects the shaking operation of the handheld mobile terminal device and sends data (e.g., frequency and amplitude information) of the shaking operation to the processor as shown in FIG. 26. The processor may compare the data with a reference shaking pattern previously set by the user and recorded in the storage media (e.g., the memory as shown in FIG. 26), and determines whether the focus of the windows should be switched based on the comparison result.

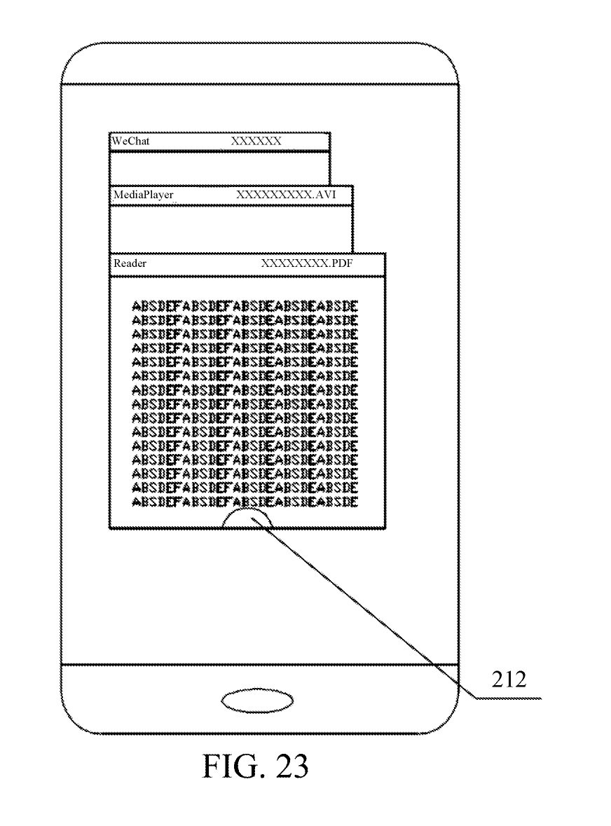

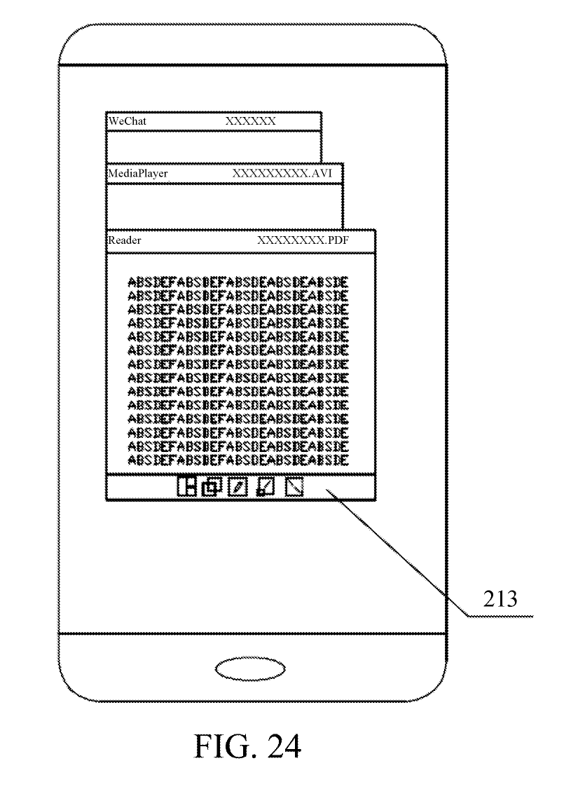

FIG. 23 shows that when the windows are in a cascade arrangement, the preset area 212 is arranged at the bottom of the focus window according to one exemplary embodiment of the present disclosure. When a user touches the preset area 212, the handheld mobile terminal device detects a first touch operation, and displays window control icons in the first area 213 as shown in FIG. 24. When the user again touches any one of the window control icons, the handheld mobile terminal device detects a second touch operation and accordingly adjusts the windows in response. Details of the window adjustment have been described above.

In the exemplary embodiments as described above, each of the windows includes a title bar at the top of the window. In certain exemplary embodiments of the disclosure, none of the windows includes a title bar, or some of the windows do not include a title bar.

When a user touches any one of the window control icons, the handheld mobile terminal device detects a second touch operation of the user, and adjusts the windows in response to the function of the window control icon corresponding to the second touch operation. For example, when a user performs the second touch operation by touching a window minimization icon, the current focus window may be minimized, or the windows of all of the applications may be minimized. In certain exemplary embodiments, it is understood that the minimization of a corresponding window refers to hiding the corresponding window, or reducing the size of the corresponding window to a preset size and presenting a preset image to the user.

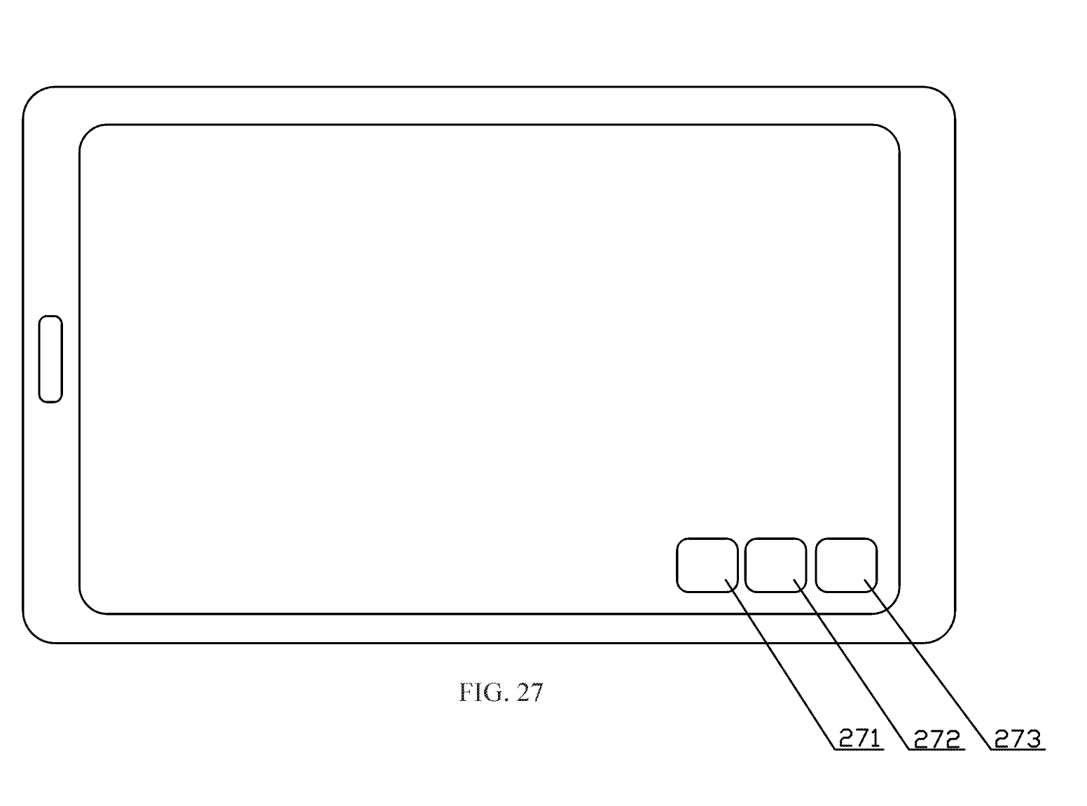

Referring to FIG. 22 as an example, after the user performs the second touch operation by touching the window minimization icon, each of the windows of all applications is reduced to a size of an icon corresponding to the application, and the corresponding icons are shown collectively in a certain area of the display screen. In certain exemplary embodiments, the certain area may be an area that the user can touch and control easily, such as the area as shown in FIG. 27. As shown in FIG. 27, three icons 271, 272, and 273, which respectively correspond to three applications, appear at a lower right corner of the display screen. The three applications may correspond to the three applications as shown in FIG. 22. As shown in the drawing, the icons are shown at the lower right corner of the display screen, which is a location that can be easily touched and controlled by a user. In certain exemplary embodiments, the icons may be displayed at the lower left corner of the display screen, which may also be easily touched and controlled by the user.

In addition, after the focus window (for example, the window where Game is located) as shown in FIG. 22 is minimized, the focus window is further moved to a location around the lower right corner of the display screen that can be more easily touched by the user during a handheld operation. In other words, as shown in FIG. 27, if the user performs a hand-held operation with both hands, the icon 273 (i.e., the Game icon) can be more easily touched by the thumb of the right hand of the user. It can be easily understood that when the user holds a handheld mobile terminal device, after a minimization operation, an operation coverage area of a thumb of the user is the area that can be more easily touched and controlled. A location that can be more easily touched by the user, i.e., the location closest to the thumb of the user, may be further defined in the operation coverage area.

When a user touches any one of the window control icons, the handheld mobile terminal device detects a second touch operation performed by the user, and adjusts the windows in response to the function of the window control icon corresponding to the second touch operation. For example, when a user performs the second touch operation by touching a window maximization icon, the focus window is displayed in full screen.

In certain exemplary embodiments, the handheld mobile terminal device 11 may be various handheld devices (for example, a mobile phone, a tablet computer, a personal digital assistant (PDA), and the like). FIG. 26 schematically shows a handheld mobile terminal device according to one exemplary embodiment of the present disclosure. As shown in FIG. 26, the handheld mobile terminal device 11 may include a processor having one or more processing cores, a radio frequency circuit, a memory including one or more non-transitory computer readable storage media, an input device, a display device, a sensor, an audio frequency circuit, a WiFi module, a power supply, and other components. A person skilled in the art may understand that the structure of the handheld mobile terminal device 11 in this exemplary embodiment does not constitute any limitation. In certain exemplary embodiments, more or less components may be included, some components may be combined, or the components may be arranged differently.

The radio frequency circuit is used for receiving and sending signals when information is received and sent or during a call process. Specifically, downlink information of a base station is processed by one or more processors after being received. In addition, uplink data may be sent to the base station. Usually, the radio frequency circuit includes, but is not limited to, an antenna, at least one amplifier, a tuner, one or more oscillators, a subscriber identity module (SIM) card, a transceiver, a coupler, a low noise amplifier (LNA), a duplexer, and the like. Further, the radio frequency circuit may communicate with other devices through radio communications and networks. The radio communications may use any communications standard or protocol, including but not limited to Global System for Mobile Communication (GSM), General Packet Radio Service (GPRS), Code Division Multiple Access (CDMA), Wideband Code Division Multiple Access (WCDMA), Long Term Evolution (LTE), an e-mail, a short message service (SMS), and the like.

The memory may be used to store one or more software programs and modules, and the processor may be used to run the software programs and modules stored in the memory, thus performing execution of the applications with various functions and processing data. In certain exemplary embodiments, the memory may mainly include a program storage area and a data storage area, where the program storage area may store an operating system, an application (for example, sound playing function, image display function, and the like) that is needed by at least one function, and the like; and the storage area may store data (for example, audio data, phone book, and the like) created according to the use of the handheld mobile terminal device 11, and the like. In certain exemplary embodiments, the memory may include a high-speed random access memory (RAM), and may also include a nonvolatile memory, for example, at least one disk storage, a flash memory, or other volatile solid-state types of memory. Correspondingly, the memory may also include a memory controller to control access to the memory by the processor and the input device.

The input device may be used for receiving input digital or character information, and generating input signals that may be related to user settings and function control, such as a keyboard input signal, a mouse input signal, a joystick input signal, an optic input signal, or a trackball input signal. Specifically, the input device may include a touch-sensitive surface, and other input devices. The touch-sensitive surface, also referred to as a touch screen or a touchpad, may collect touch operations performed by a user on or near the touch-sensitive surface (for example, operations performed on or near the touch-sensitive surface by a user using any proper object or accessory, such as a finger, a stylus, and the like), and drive a corresponding connected apparatus according to a preset program. Optionally, the touch-sensitive surface may include two parts, including a touch detection apparatus and a touch controller. The touch detection apparatus is configured to detect a location of a touch performed by a user, to generate a signal caused by the touch operation, and to transmit the signal to the touch controller. The touch controller is configured to receive touch information in the signal from the touch detection apparatus, to convert the touch information into a touch point coordinate, and to send the touch point coordinate to the processor. The touch controller may also receive and execute a command sent by the processor. In addition, the touch-sensitive surface may be implemented in multiple types, such as a resistive type, a capacitive type, an infrared type, and a surface acoustic wave type. In addition to the touch-sensitive surface, the input device may further include other input devices. Specifically, the other input devices may include, without being not limited to, one or more of a physical keyboard, a function key (for example, a volume control key, an on/off key, and the like), a trackball, a mouse, and a joystick.

The display device may be used for displaying information input by a user or information provided to a user, and various graphic user interfaces of the handheld mobile terminal device 11. These graphic user interfaces may be formed by images, texts, icons, videos, and any combination thereof. The display device may include a display panel. Optionally, the display panel may be configured by using a liquid crystal display (LCD), an organic light-emitting diode (OLED), and the like. Further, the touch-sensitive surface may cover the display panel, and after detecting a touch operation on or near the touch-sensitive surface, the touch-sensitive surface may send a touch event to the processor so that the processor determines the type of the touch event. Then, the processor provides a corresponding display output on the display panel according to the type of the touch event. In certain exemplary embodiments, the touch-sensitive surface and the display panel are configured to respectively implement the input and output functions as two independent components. Alternatively, in certain exemplary embodiments, the touch-sensitive surface and the display panel may be integrated as one component to implement the input and output functions.

The handheld mobile terminal device 11 may further include at least one sensor, for example, a light sensor, a motion sensor, and other sensors. Specifically, the light sensor may include an ambient light sensor and a proximity sensor, where the ambient light sensor may adjust the brightness of the display panel according to the luminance of the ambient light. The proximity sensor may turn off the display panel and/or a backlight when the handheld mobile terminal device 11 is moved to an ear. A gravitational acceleration sensor, which is one type of the motion sensors, may detect the magnitude of an acceleration in each direction (usually in three axes), and may detect the magnitude and direction of the gravity in a static state. Thus, it may be used for an application recognizing an attitude of a mobile phone (for example, landscape/portrait switch, a related game, and magnetometer attitude calibration), and vibration identification related functions (for example, pedometer and knock), and the like. The handheld mobile terminal device 11 may include other types of sensors, such as a gyroscope, a barometer, a hygrometer, a thermometer, and an infrared sensor, which are not elaborated herein.

The audio frequency circuit, a loudspeaker, and a microphone may provide an audio interface between a user and the handheld mobile terminal device 11. The audio frequency circuit may transmit an electrical signal converted from received audio data to the loudspeaker, and the loudspeaker converts the electrical signal into a sound signal and outputs the sound signal. On the other hand, the microphone converts a collected sound signal into an electrical signal, and the audio frequency circuit receives and converts the electrical signal into audio data. After the audio data is sent to and processed by the processor, the processed audio data is sent by the radio frequency circuit to, for example, another apparatus, or is output to the memory for further processing. The audio frequency circuit may further include an earplug jack to provide communications between a peripheral earphone and the handheld mobile terminal device 11.

WiFi belongs to the short-range radio transmission technology. By means of the WiFi module, the handheld mobile terminal device 11 can assist a user to receive or send an e-mail, browse a webpage, access streaming media, and the like; the WiFi module provides a wireless broadband internet access for the user. Although the WiFi module is provided in this exemplary embodiment, it can be understood that the WiFi module is not a mandatory component of the mobile terminal device 11, and may be omitted based on the need without changing the essence of the present disclosure.

The processor is a control component of the handheld mobile terminal device 11, which is connected to all other components through various interfaces and circuits. The processor is configured to run or execute the software programs and/or modules stored in the memory and to retrieve the data stored in the memory to perform execution of various functions and data processing, so as to perform overall monitoring of the mobile phone. Optionally, the processor may include one or more processing cores. In certain exemplary embodiments, the processor integrates an application processor and a modem processor, where the application processor mainly processes an operating system, a user interface, an application, and the like, and the modem processor mainly processes radio communication. It can be understood that the modem processor may not necessarily be integrated in the processor.

In certain exemplary embodiments, the handheld mobile terminal device 11 further includes a power supply (for example, a battery) to provide power to each component. In certain exemplary embodiments, the power supply may be logically connected to the processor through a power supply management system, so that functions such as charging, discharging, and power management are implemented by the power supply management system. The power supply may further include any other component such as one or more direct current or alternating current power supplies, a recharging system, a power supply fault detection circuit, a power supply converter or inverter, and a power status indicator.

Although it is not explicitly shown, the handheld mobile terminal device 11 may further include a camera, a Bluetooth module, and the like, which is not elaborated herein. Specifically, in this exemplary embodiment, the display device of the handheld mobile terminal device 11 is a touch screen display, and the handheld mobile terminal device 11 further includes a memory and one or more programs, where the one or more programs are stored in the memory, and are configured to be executed by one or more processors.

The software program and module stored in the memory are executed by the processor to implement the various processes and methods as mentioned above. In one or more exemplary embodiments of the present disclosure, a non-transitory computer readable storage medium such as a disk, a compact disc, a semiconductor memory is further included for storing computer readable program code therein. When the program code is executed, the various processes and methods as mentioned above may be implemented.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The exemplary embodiments were chosen and described in order to explain the principles of the disclosure and their practical application so as to activate others skilled in the art to utilize the disclosure and various exemplary embodiments and with various modifications as are suited to the particular use contemplated. Alternative embodiments will become apparent to those skilled in the art to which the disclosure pertains without departing from its spirit and scope. Accordingly, the scope of the disclosure is defined by the appended claims rather than the foregoing description and the exemplary embodiments described therein.

What is claimed is:

1. A window control method configured for a handheld mobile terminal device having a touch screen, wherein the handheld mobile terminal device comprises a plurality of applications respectively corresponding to a plurality of windows, the method comprising:
detecting a first touch operation in a preset area of the touch screen;
if the first touch operation is detected in the preset area, displaying a window control icon in a first area of the touch screen;
detecting a second touch operation corresponding to the window control icon in the first area; and
if the second touch operation corresponding to the window control icon is detected in the first area, transforming the windows in response to the second touch operation.

2. The window control method according to claim 1, wherein the window control icon comprises a window cascade icon, and wherein the step of transforming the windows in response to the second touch operation comprises:
adjusting all of the windows to a preset size; and
performing a cascade arrangement to the windows in a manner using a focus window prior to the adjusting as a current window,
wherein at least some of the windows are partially invisible.

3. The window control method according to claim 2, wherein the cascade arrangement comprises: arranging at least one edge of each of the windows on a same straight line; or arranging all of the windows in an arc/annular cascaded arrangement; or arranging all of the windows in a distributed cascaded arrangement.

4. The window control method according to claim 1, wherein the window control icon comprises a tile icon, the number of the windows is N, and N is an positive integer, and wherein the step of transforming the windows in response to the second touch operation comprises:
when N is an even number, dividing a display area of the touch screen by N to obtain N display sub-areas for displaying the N windows correspondingly.

5. The window control method according to claim 1, wherein the number of the windows is N, and N is an positive integer, and wherein the step of transforming the windows in response to the second touch operation comprises:
when N is an odd number greater than 1, dividing a display area of the touch screen by N−1 to obtain N−1 display sub-areas, and dividing one of the N−1 display sub-areas into two secondary areas, wherein the N−2 undivided display sub-areas and the two secondary areas are used for displaying the N windows correspondingly.

6. The window control method according to claim 1, wherein the preset area is located at a display edge of the touch screen, or at an edge of a current window.

7. The window control method according to claim 1, wherein the first area is bar-shaped, and at least one edge of the first area is adjacent to or connected to a display edge of the touch screen or an edge of a current window.

8. The window control method according to claim 1, further comprising:
detecting a third touch operation in the preset area; and
if the third touch operation is detected in the preset area, hiding the window control icon.

9. The window control method according to claim 1, wherein the step of displaying a window control icon in a first area of the touch screen comprises:
continuously moving the window control icon from a display edge of the touch screen to the first area.

10. The window control method according to claim 1, further comprising:
if the second touch operation corresponding to the window control icon is not detected in the first area within a preset period of time, hiding the window control icon.

11. A window control method configured for a handheld mobile terminal device having a touch screen, wherein the handheld mobile terminal device comprises a plurality of applications respectively corresponding to a plurality of windows, the method comprising:
detecting a touch operation corresponding to an image button;
displaying a window control icon in a first area of the touch screen;
detecting a touch operation corresponding to the window control icon in the first area; and
transforming the windows in response to the touch operation corresponding to the window control icon.

12. A handheld mobile terminal device, comprising:
a touch screen;
one or more processors; and
a non-transitory storage medium storing a computer readable program code, wherein the computer readable program code stored in the non-transitory storage medium is configured to be executed by the one or more processors to implement a window control method, the method comprising:
detecting a first touch operation in a preset area of the touch screen;
if the first touch operation in the preset area is detected, displaying a window control icon in a first area of the touch screen;
detecting a second touch operation corresponding to the window control icon in the first area; and
if the second touch operation corresponding to the window control icon is detected in the first area, transforming the windows in response to the second touch operation.

13. The handheld mobile terminal device according to claim 12, wherein the window control icon comprises a window cascade icon, and wherein the step of transforming the windows in response to the second touch operation comprises:
adjusting all of the windows to a preset size; and
performing a cascade arrangement to the windows in a manner using a focus window prior to the adjusting as a current window,
wherein at least an identification part of each of the windows is visible.

14. The handheld mobile terminal device according to claim 13, wherein the cascade arrangement comprises: arranging at least one edge of each of the windows on a same straight line; or arranging all of the windows in an arc/annular cascaded arrangement; or arranging all of the windows in a distributed cascaded arrangement.

15. The handheld mobile terminal device according to claim 12, wherein the window control icon comprises a tile icon, the number of the windows is N, and N is an positive integer, and wherein the step of transforming the windows in response to the second touch operation comprises:
when N is an even number, dividing a display area of the touch screen by N to obtain N display sub-areas for displaying the N windows correspondingly.

16. The handheld mobile terminal device according to claim 12, wherein the number of the windows is N, and N is an positive integer, and wherein the step of transforming the windows in response to the second touch operation comprises:
when N is an odd number greater than 1, dividing a display area of the touch screen by N−1 to obtain N−1 display sub-areas, and dividing one of the N−1 display sub-areas into two secondary areas, wherein the N−2 undivided display sub-areas and the two secondary areas are used for displaying the N windows correspondingly.

17. The handheld mobile terminal device according to claim 12, wherein the preset area is located at a display edge of the touch screen, or at an edge of a current window.

18. The handheld mobile terminal device according to claim 12, wherein the first area is bar-shaped, and at least one edge of the first area is adjacent to or connected to a display edge of the touch screen or an edge of a current window.

19. The handheld mobile terminal device according to according to claim 12, wherein the method further comprises:
detecting a third touch operation in the preset area; and
if the third touch operation is detected in the preset area, hiding the window control icon.

20. The handheld mobile terminal device according to claim 12, wherein the step of displaying a window control icon in a first area of the touch screen comprises:
continuously moving the window control icon from a display edge of the touch screen to the first area.

21. The handheld mobile terminal device according to claim 12, wherein the method further comprises:
if the second touch operation corresponding to the window control icon is not detected in the first area within a preset period of time, hiding the window control icon.
